(19) United States
(12) Patent Application Publication
(10) Pub. No.: US 2018/0158026 A1
(43) Pub. Date: Jun. 7, 2018

(54) Process and system for connecting employers and potential temporary employees

(71) Applicants: Efthimios Zentefis, Coconut Creek, FL (US); Rafael Calero, DEERFIELD BEACH, FL (US)

(72) Inventors: Efthimios Zentefis, Coconut Creek, FL (US); Rafael Calero, DEERFIELD BEACH, FL (US)

(21) Appl. No.: 15/368,660

(22) Filed: Dec. 4, 2016

(51) Int. Cl. G06Q 10/10; H04L 29/08; G06Q 20/10

(52) U.S. Cl. CPC G06Q 10/1053; G06Q 50/01; G06Q 20/102; H04L 67/306

(57) ABSTRACT

The current invention is system and application in which an employer can list jobs that they need temporary employees for and potential employees can apply for those jobs. employer and employee would register and login. The employer would either list or post the temporary jobs that they are looking to hire for. The potential employee would use the system to see the jobs and post the experience and background as well as other information desired by the employee. The employer would use the employees information to determine whether to hire them for the job or not.

### CROSS-REFERENCES TO RELATED APPLICATIONS (IF ANY)

None

### BACKGROUND

### 1. Field of the Invention

The present invention relates to a process to connect employers and temporary employee and in more particularly for use with a mobile phone app.

### 2. Description of Prior Art

Currently, there are no quick and easy to use mobile phone applications to connect employers with prospective temporary employees that is easy to use and takes care of the hiring process.

There is still room for improvement in the art.

### SUMMARY OF THE INVENTION

The current invention is system and application in which an employer can list jobs that they need temporary employees for and potential employees can apply for those jobs.

The system, in the preferred embodiment, would work like a smartphone application, this product would be available through the respective marketplace for smartphones.

The process would be that an employer would register and login. They would either list or post the temporary jobs that they are looking to hire for.

The potential employee would use the system to see the jobs and post the experience and background as well as other information desired by the employee.

The employer would review the employee's information and use that information to either hire or decline the employee.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 shows the functions with an employer;

FIG. 3 shows the functions with an employee;

FIG. 4 displays the management components;

FIG. 5 shows a sample of a login screen;

FIG. 6 shows a job posting;

FIG. 7 shows a sample page of employee inputs; and

FIG. 8 displays the hire or do not hire screen.

### DESCRIPTION OF THE PREFERRED EMBODIMENT

There are a number of significant design features and improvements incorporated within the invention.

The current invention is a system and application to connect employers and temporary employees.

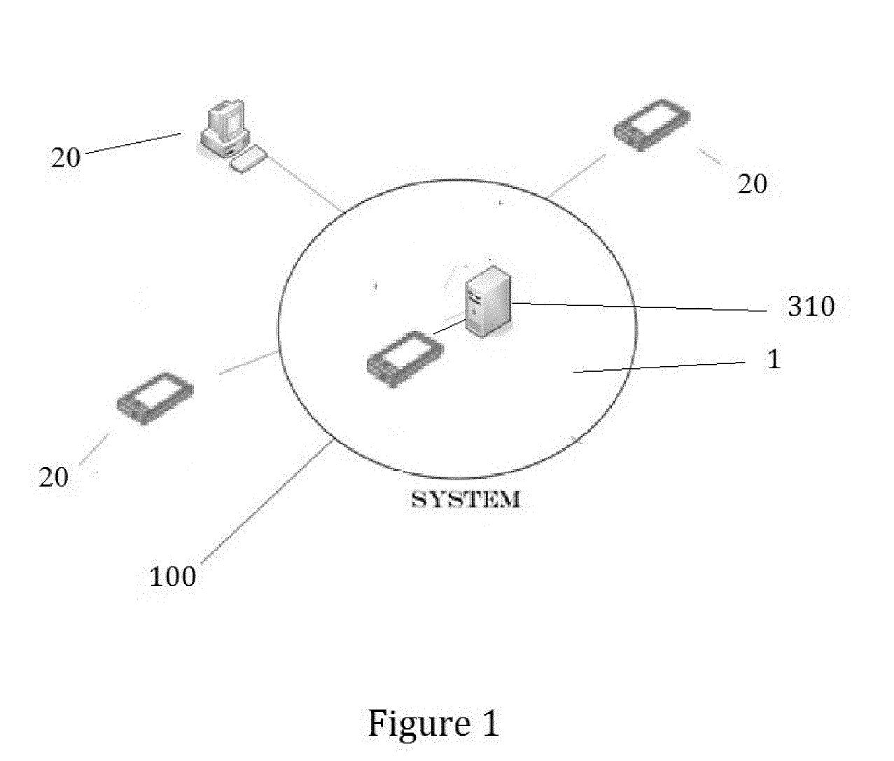

FIG. 1 displays the preferred embodiment of the system architecture 1 accessed through an Internet, Intranet and/or Wireless network 500. However, the system could be implemented on a device-to-device or client/server architecture as well.

In FIG. 1, the system 1 is accessed from a user's computing device 10 through a web browser over HTTP and/or HTTPS protocols 500 or wireless network or cell phone to cell phone connection. A computing device 20, such as a cell phone, that can access the system 1 must have some version of a CPU, CPU memory, local hard disk, keyboard/keypad/input and display unit. The computing device 20 can be any desktop, laptop, tablet, smart phone or general purpose computing device with an appropriate amount of memory suitable for this purpose and an active connection to the Internet 500. Computing devices like this are well known in the art and are not pertinent to the invention.

The system 1, data and processing code can reside in the non-transitory memory 310 of the one or more computing devices. The system 1 in the preferred embodiment would be written to act like a smart phone application (app) where the different apps can communicate with each. The system 1 may work with a central server as shown in FIG. 1 or in parallel which each computing device 10 or smartphone communicating with others within the system 1.

The system 1, data and processing code can reside in the non-transitory memory 310 of the one or more computing devices. The system 1 in the preferred embodiment would be written to act like a smart phone application (app).

### Brief Overview

This current invention is a system 1 and computer application that is aimed to make it easy for employers who desire to hire temporary employees to find and hire those employees while making it easy for users who are looking for temporary employment to find jobs.

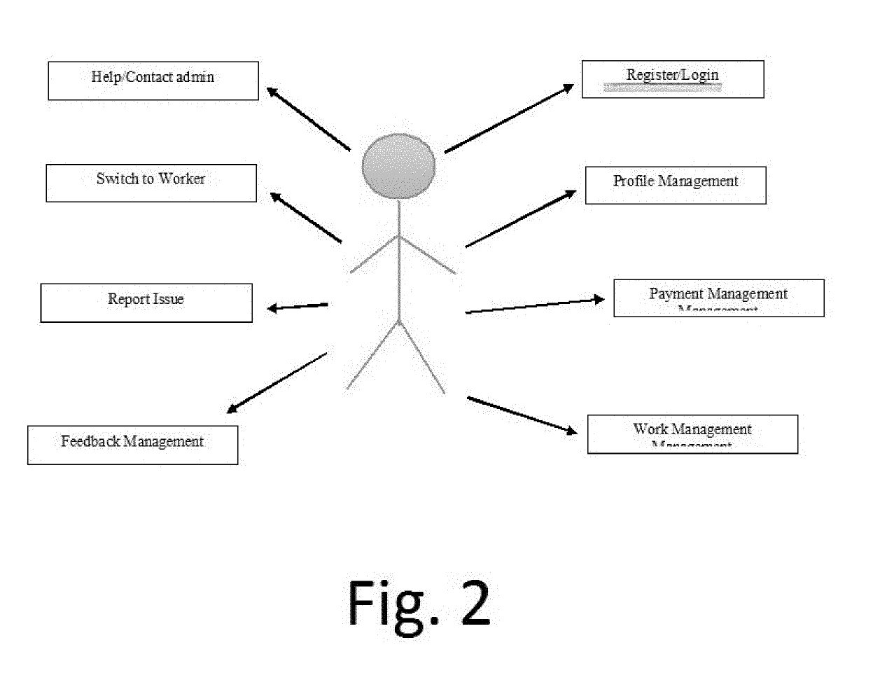

The process, as shown in FIG. 2, for the employer is as follows. The employers can download the application and register/login by Email address or social network.

The user will set up their profile for the system using one or more profile screens. The employer needs to enter his profile information as general information like name, date of birth, gender, etc. The employer can add a profile picture and their business details. The employer can also edit his profile at any time. The employer needs to enter a tax id number such as an EIN or Social Security Number (SSN) for verification.

The system 1 will have a payment screen will be set up account details to accept any normal method of payment. At this screen the employer will add his payment options such as Credit cards, bank accounts or Paypal.

The employer will post the job that they are interested in hiring a temporary employee. The employer will give the description of the job, the length of job, skill set or degree needed and when the position is needed.

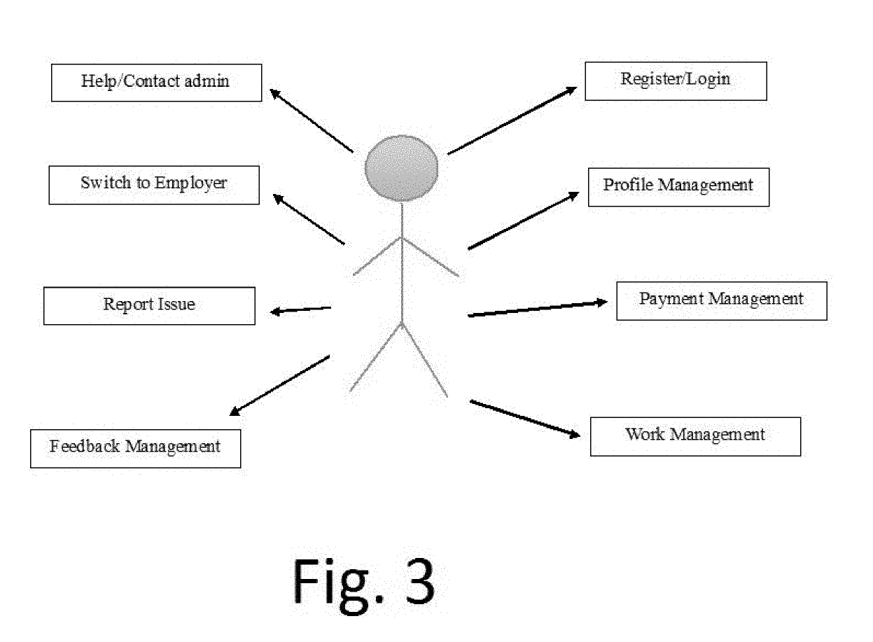

The employee process is shown in FIG. 3. The employee will use the system 1 and will register/Login. The employee can download the application and register/login by Email address or Social network.

The employee would need to enter his profile information as general information like name, date of birth, gender, etc. The employee can add a profile picture and their area of expertise. The employee can also edit his profile at any time.

The employee would need to enter their tax id number like Social Security Number (SSN) for verification.

The system 1 will manage the payment process for the employee. The employee can be paid by cash, check, bank account, credit cards or Paypal.

After the job is completed, the system 1 will generate an invoice and invoice will be shown with the amount to be paid to them. They system 1 may or may not deduct an admin's share or percentage of the fees paid.

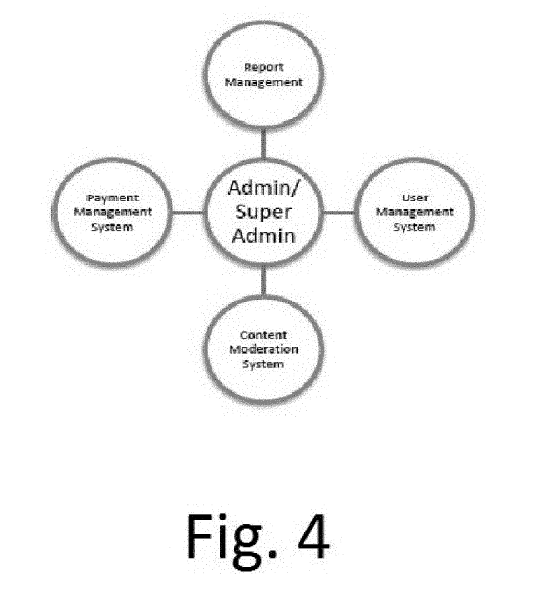

The system 1 will offer management components as shown in FIG. 4.

The new jobs are posted by the employer. The employee can view all new jobs. The job details include: Job description, the amount to be paid, the time frame within which he can accept the job and the time required for work

In the preferred embodiment, the employee has three options:

ACCEPT the job.

REJECT the job and the job will not be shown on his screen anymore.

COUNTEROFFER/NEGOTIATION for higher pay. The employee can request for a higher pay and wait for the employer to increase the amount. If the employer does so then new price is shown to employee and again the same process can continue until the employee is satisfied with the pay. Otherwise, if in the meantime the job is allocated to any other employee, then the job will be no longer be available.

Once the job is accepted (after the employee accepts and the employer approves it), the amount specified by the employer will be deducted from their account and held by the admin and paid to the employee. The system 1 may keep a fee for processing. The employer may also directly pay the employee.

An invoice will be generated and displayed to employer once the job is completed and the employer approves of it. Otherwise, if the job is not completed or employer does not approve of it then only a base amount is deducted.

If the employee does not show up or does not complete their job then no amount will be paid to them and they can even get banned from the app. In all the cases, the final amount to be paid is decided by the employer.

The system 1 will have the employee's work history. The employee and potential employer can view their previous work history, the employer's profile, and the ratings/reviews given.

The system 1 will have a feedback management function for both the employee and employer. Once the job is completed, the employee can provide reviews and ratings for the employer and the employer can provide reviews and rating for the employee. This can help the employee to decide to work for the same employer again or not and allow the employers more information on whether or not to hire an employee.

The system 1 will have a option of where a employee or employer with bad ratings can be banned.

The employee can report about issues to the admin regarding the employer, or the application.

The system 1 will have an administration function as shown in FIG. 4. It can charge a percentage of amount from employer and employee for using the app. The system 1 will have surge pricing where the surge rate can increase in cases when less employees are available i.e the surge rate is more at 2 am rather than 5 pm.

The admin function makes sure that a employee's pay cannot be below a certain amount which is decided based upon the minimum wage law and labor laws per state.

### Operation

As an example, an employer owned a restaurant with 60 employees, had 10 applications per week, but the employer didn't need anyone most of the times. Sometimes though they needed an extra hand for a few hours. The employer would like to go on an app that I post, need a dishwasher for 6 hours, needs to be here in one hour. The employer will pay 60$. The people that log in the app that need work will see it and the first one that presses will be there, come to work. The app then will hold 60$ from the employer. Once the employee shows up, the app collects the money. The app will then send the payment to the employee.

The system 1 provides a fast, easy way for an employer to quickly fill his last minute employee needs.

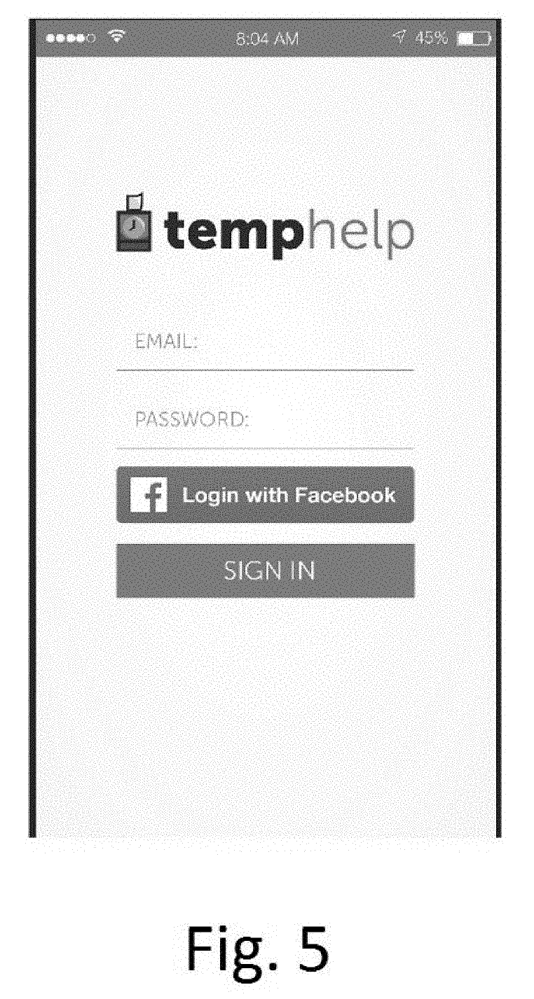

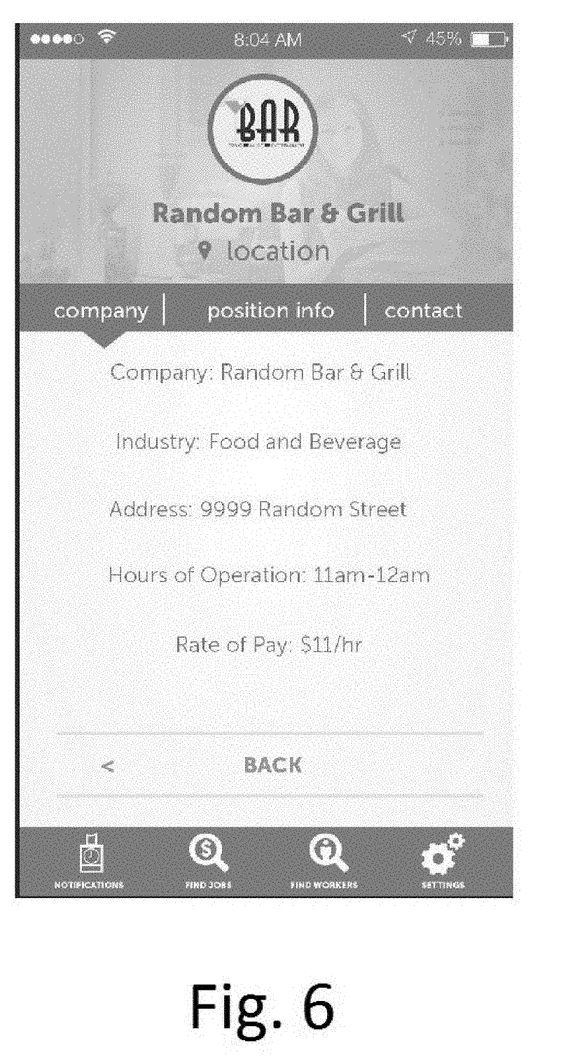

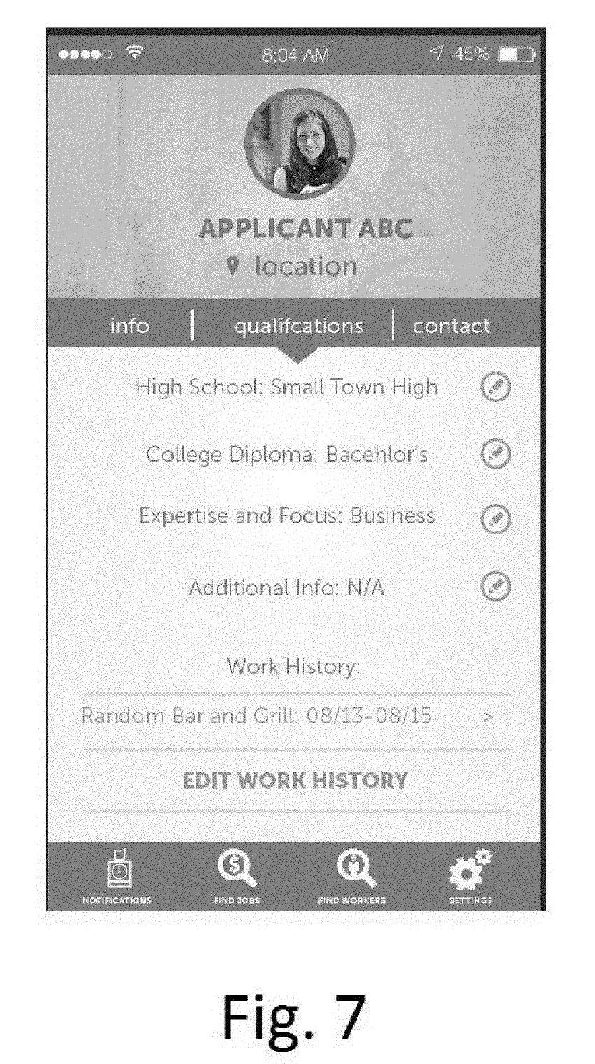

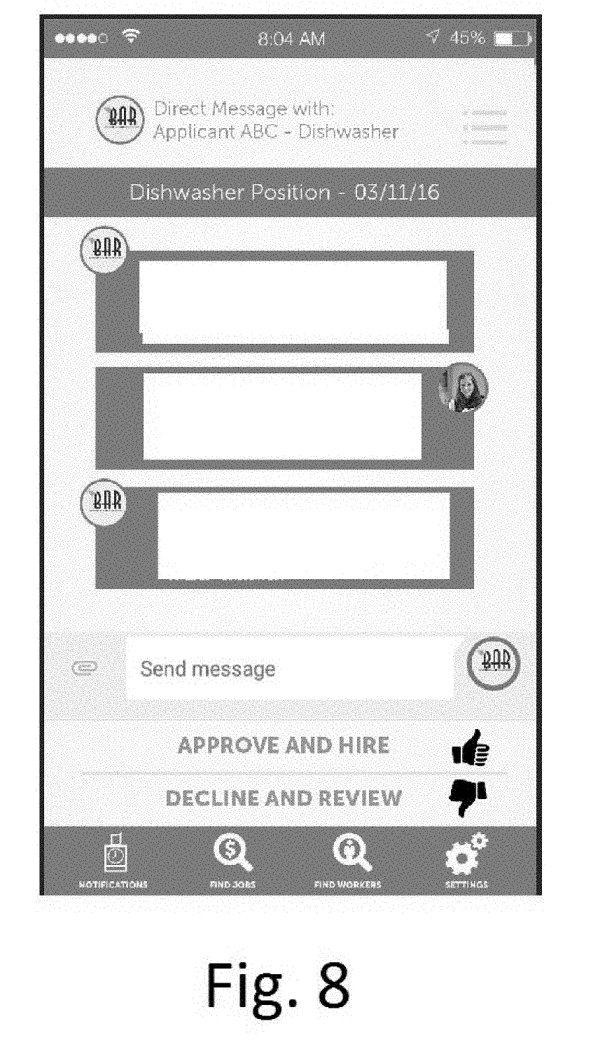

FIG. 5 shows a sample login screen for the system. Both the employer and potential employees will login and create a profile on the system. FIG. 6 shows a sample job posting. FIG. 7 shows a sample page of employee inputs and information on which the employer will make a hiring decision on. FIG. 8 displays the hire or do not hire screen where the employer will hire or decline a potential temporary employee.

### CONCLUSION

What makes the system different is the user can turn their availability on/off in real time as they want jobs that day. The application is for short, on demand jobs and not careers. A business user can access on demand support for their business or household. The employees can be looking to make additional money or make a living and can work as much or as little as they desire.

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising;
having a system that resides in the non-transitory memory of a computing device;
displaying a plurality jobs posted by employers, having employees apply for those jobs, and the employer hiring or not hiring an employee.

2. A system according to claim 1 having the employees set up profiles.

3. A system according to claim 1 having the employers set up profiles.

4. A system according to claim 1 having the jobs be temporary jobs.

5. A system according to claim 1 having a rating and feedback system for both employers and employees.

6. A system according to claim 2 where profile information consists of one or more of a set of name, date of birth, gender, profile picture and business details.

7. A system according to claim 6 where employer can edit the profile at information.

8. A system according to claim 3 where profile information consists of one or more of a set of name, date of birth, gender, profile picture and work history.

9. A system according to claim 8 where employee can edit the profile at information.

10. A system according to claim 1 having a payment process.

11. A system according to claim 10 having the employer pay the system and the system pay the employee.

12. A system according to claim 1 where the employee can accept, rejection or counteroffer a employment offer.

13. A system according to claim 14 where the employee can request a higher pay.

14. A system comprising;
having a system that resides in the non-transitory memory of a computing device;
displaying a plurality jobs posted by employers, having employees apply for those jobs, and the employer hiring or not hiring an employee, having the employee accept, rejection or counteroffer an employment offer and having a payment system for the employer to pay the employee.

15. A system according to claim 14 having the employees set up editable profiles.

16. A system according to claim 14 having the employers set up editable profiles.

17. A system according to claim 14 having the jobs be temporary jobs.

18. A system according to claim 14 having a rating and feedback system for both employers and employees.

19. A system according to claim 14 having a payment process.

20. A system according to claim 14 where the employee can request a higher pay.
